(19) United States
(12) Patent Application Publication
(10) Pub. No.: US 2010/0269853 A1
(43) Pub. Date: Oct. 28, 2010

(54) DEBRIS-EXTRACTION EXHAUST SYSTEM

(75) Inventors: BENJAMIN JOHNSTON, Los Gatos, CA (US); Shinichi Kurita, San Jose, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/430,249

(22) Filed: Apr. 27, 2009

(51) Int. Cl. B08B 6/00; A47L 5/14; A47L 9/10; B08B 5/04; B08B 7/04; A47L 9/00

(52) U.S. Cl. 134/1.1; 15/345; 15/346; 15/347; 134/21; 134/10; 15/1.51

(57) ABSTRACT

Systems and methods for debris extraction reduce the lifting force on the workpiece through a supply air feature. The supply air feature can be implemented through an extraction nozzle, which has an outer supply duct surrounding an inner exhaust duct. Further reduction of the lifting force can be realized through the use of multiple extraction nozzles which limit exhaust airflow to areas of the workpiece with active laser scribing.

### CROSS-REFERENCES TO RELATED APPLICATIONS

This application claims the benefit of U.S. Provisional Patent Application No. 61/050,944, filed May 6, 2008, entitled “RECIRCULATING EXHAUST FOR DEBRIS EXTRACTION,” which is hereby incorporated herein by reference.

### BACKGROUND OF THE INVENTION

Various embodiments described herein relate generally to approaches for extracting debris and other material using an exhaust system, and in some instances relate specifically to an exhaust system that extracts debris for a laser-scribing system, as well as methods and apparatus for using such an exhaust system. Many of these methods and apparatus can be particularly effective when applied to extract debris in a laser-scribing system that is used to form thin-film multi-junction solar cells.

Current methods for forming thin-film solar cells involve depositing or otherwise forming a plurality of layers on a substrate, such as a glass, metal or polymer substrate suitable to form one or more p-n junctions. An example of a solar cell has an oxide layer (e.g., a transparent conductive oxide (TCO)) deposited on a substrate, followed by an amorphous silicon layer and a metal back layer. Examples of materials that can be used to form solar cells, along with methods and apparatus for forming the cells, are described, for example, in co-pending U.S. patent application Ser. No. 11/671,988, filed Feb. 6, 2007, entitled “MULTI-JUNCTION SOLAR CELLS AND METHODS AND APPARATUSES FOR FORMING THE SAME,” which is hereby incorporated herein by reference. When a solar panel is being formed from a large substrate, a series of laser-scribed lines is typically used within each layer to delineate individual cells.

The laser-scribed lines are formed by ablating material from a workpiece, which consists of a substrate and deposited layers. This is achieved by concentrating a large amount of energy into a very short duration laser pulse and choosing the optimal laser wavelength to couple with the material. When the correct conditions for ablation are achieved, the material is removed in an explosive plume that contains debris. Debris from the laser-scribing process is normally removed using an extraction unit. In previous approaches, the debris is captured in a close fitting hood and then conveyed, entrained in air, by ductwork to a debris-extraction unit where the debris is removed from the airflow. The airflow used to remove the debris imparts a large lifting force on the workpiece, which in turn affects the distance between the workpiece and the laser. If the airflow is reduced to lower the lifting force on the workpiece, then the air velocity might become too low to effectively remove all debris. Therefore, there is a need for an improved exhaust system that will effectively and efficiently remove debris without imparting a large lifting force.

The previous approaches also exhibited other deficiencies. For example, the close-fitting hood formed an enclosure over a portion of the workpiece that was being scribed. Airflow from the exhaust system made it difficult to control the stability of the temperature inside the enclosure, which is critical to the laser-scribing process due to sensitivity of the laser scanners to temperature. Furthermore, an exhaust system with a large exhaust load and air conditioning requirement increased operational costs.

Accordingly, it is desirable to develop systems and methods that overcome at least some of these, as well as potentially other, deficiencies in existing debris-extraction systems and methods for laser scribing and solar panel manufacturing devices. Further, it can also be seen that this need for better debris extraction may also exist for direct patterning of large masks for flat panel displays and direct patterning for other large display applications, such as black matrix ablation.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Systems and methods for extracting debris from a workpiece during laser scribing are provided. Various embodiments can provide for efficient and effective debris removal from an active area of a workpiece by introducing a flow of supply air to an active area of the workpiece. The flow of supply air can help reduce the magnitude of the lifting force imparted on the workpiece. Additionally, the flow of supply air can help to stabilize the temperature within the active area, which may help to stabilize the laser-scribing process. Such systems and methods can be configured for reduced exhaust system load and/or reduced air conditioning and/or heating requirements, thereby lowering costs, such as initial cost and operational cost.

In an embodiment, a debris-extracting exhaust system is provided. The system includes an extraction nozzle that includes at least one debris-extraction orifice. Each debris-extraction orifice is configured for placement adjacent to an active area of a workpiece. The system includes a source of exhaust operable to extract a flow of exhaust and debris from the active area through each debris-extraction orifice. The extraction nozzle includes, for each debris-extraction orifice, a first duct coupled with the debris-extraction orifice and a second duct coupled with the debris-extraction orifice. The second duct is configured to deliver a flow of supply air towards the active area and the first duct is configured to remove a flow of exhaust air and debris from the active area.

A debris-extracting exhaust system can involve a variety of options. For example, the second duct can enclose at least a portion of the first duct. The second duct can discharge the supply air at the perimeter of the debris-extraction orifice. A system can include a filtering device for removing the debris from the flow of exhaust air, whereby the filtered exhaust air is able to be re-circulated into the flow of supply air. The filtering device can include a particle filter and/or a chemical filter. Each debris-extraction orifice can be configured to extract debris from a single laser-scribing area, wherein the laser-scribing area is an area of the workpiece that can be processed by a laser scanner. A system can include a translation mechanism for moving the extraction nozzle so that each debris-extraction orifice is moved in coordination with movement of the active area. The system can be configured to ensure that airflow velocities within the first duct are sufficiently high to capture and convey substantially all debris from the workpiece, and to ensure that no vortex is formed within the first duct that will trap the debris and prevent the debris from being conveyed along the first duct. The system can be configured such that a separation distance between the debris-extraction orifice and the workpiece is adjustable. The extraction nozzle can include at least one end piece that can be removed for maintenance, cleaning, and/or geometric modification. Each end piece can define the debris-extraction orifice. The system can be configured such that a pressure differential between opposing sides of the active area is less than a desired value.

In another embodiment, a method of using airflow to remove debris from a workpiece is provided. The method includes providing a flow of supply air, discharging the flow of supply air toward an active area of a workpiece, and extracting a flow of exhaust air and debris from the active area through a debris-extraction orifice.

A method of using airflow to remove debris from a workpiece can involve a variety of options. For example, the direction and rate of flow of the supply air can be sufficient to maintain a minimum separation between the workpiece and the debris-extraction orifice. A method can include filtering the flow of exhaust air to substantially remove the debris and re-circulating air from the filtered flow of exhaust air into the flow of supply air. The flow of exhaust air can be filtered by processing through a particle filter and/or a chemical filter. The discharge of the flow of supply air and the extraction of the flow of exhaust air can be substantially limited to one or more areas of the workpiece that are being laser scribed. The flow of supply air can be provide through a first duct to deliver the flow of supply air along an extraction nozzle toward the active area. The flow of exhaust air and debris can be extracted through a second duct to deliver the exhaust air and debris along the extraction nozzle away from the active area.

In another embodiment, a debris-extracting exhaust system is provided. The system includes a plurality of extraction nozzles with each nozzle including a debris-extraction orifice configured for placement adjacent to an associated active area of a workpiece. The system further includes a source of supply air operable to direct a flow of supply air through a first duct of each extraction nozzle toward the associated active area, and a source of exhaust operable to extract a flow of exhaust air and debris from the associated active area through each second duct.

A debris-extracting exhaust system can involve a variety of options. For example, the direction and rate of flow of the supply air can be sufficient to maintain a minimum separation between the workpiece and each extraction nozzle. A system can be configured such that a pressure differential between opposing sides of each active area is less than a desired value. A system can include a filtering device for removing debris from the flows of exhaust air, whereby the filtered exhaust air is able to be re-circulated into the flows of supply air. A system can include a translation mechanism for moving the extraction nozzles so that each debris-extraction orifice is moved in coordination with movement of its associated active area.

For a fuller understanding of the nature and advantages of the present invention, reference should be made to the ensuing detailed description and accompanying drawings. Other aspects, objects and advantages of the various embodiments will be apparent from the drawings and detailed description that follows.

### BRIEF DESCRIPTION OF THE DRAWINGS

Various embodiments in accordance with the present invention will be described with reference to the drawings, in which:

FIG. 1 illustrates a perspective view of a laser-scribing device that can be used in accordance with an embodiment;

FIG. 2 illustrates an end view of a laser-scribing device that can be used in accordance with an embodiment;

FIG. 3 illustrates components of an exhaust system that can be used in accordance with an embodiment;

FIG. 4 illustrates a perspective view of eight extraction nozzles belonging to an exhaust system that can be used in accordance with an embodiment;

FIG. 5 illustrates a perspective view of connecting ductwork for eight extraction nozzles (shown in FIG. 4) belonging to an exhaust system that can be used in accordance with an embodiment;

FIG. 6 illustrates a perspective view of an extraction nozzle that can be used in accordance with an embodiment;

FIG. 7 illustrates a cross-sectional view of an extraction nozzle (shown in FIG. 6) that can be used in accordance with an embodiment;

FIG. 8 illustrates a debris-extraction orifice of an extraction nozzle (together with an image of a scan field to show the size of a debris-extraction orifice relative to the size of the scan field) that can be used in accordance with an embodiment;

FIG. 9 illustrates the flow of “supply air” and “exhaust air” near a debris-extraction orifice that can be used in accordance with an embodiment; and

FIG. 10 illustrates computer simulation results for air flow velocities in an extraction nozzle that can be used in accordance with an embodiment.

### DETAILED DESCRIPTION

In the following description, various embodiments of the present disclosure will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Systems and methods in accordance with various embodiments of the present disclosure can overcome one or more of the aforementioned and other deficiencies in existing debris-extracting exhaust system approaches. Various embodiments can provide for greatly reduced lifting force on the workpiece, which may help maintain a desired workpiece separation distance, as well as to provide better temperature control and lower operating cost. Devices in accordance with various embodiments can provide efficient and effective exhaust system approaches for removing debris through the use of multiple extraction nozzles, which can be shaped to only cover each individual laser-scribing areas and which can be configured to move together with the laser-scribing areas. These systems and methods can be particularly effective when applied to debris-extracting exhaust systems for laser scribing and solar panel manufacturing devices. They can also be effective in other applications, such as when applied to debris-extracting exhaust systems for direct patterning of large masks for flat panel displays and direct patterning for other large display applications such as black matrix ablation.

In many embodiments, efficient and effective debris extraction from an active area of a workpiece may be realized with an exhaust system having a supply air feature that delivers a flow of supply air to the active area. A flow of exhaust air containing debris and at least a portion of the supply air is then extracted from the active area. The flow of supply air helps to avoid subjecting the active area to reduced pressure that may exist in some prior exhaust systems. In some prior exhaust systems, the flow of exhaust air is drawn from outside of an exhaust nozzle through a gap between the exhaust nozzle and the workpiece. The flow of air through the gap creates a pressure drop, which typically creates a lifting force on the workpiece due to the lack of a balancing pressure drop on the opposing side of the active area. A debris-extraction exhaust system having a flow of supply air can be configured such that a pressure differential between opposing sides of the active area is less than a desired value (e.g., less than 1.0 psi as a non-limiting example). By avoiding this reduction in pressure, the introduction of the flow of supply air reduces the lifting force imparted on the workpiece. The reduced lifting force helps to ensure that the exhaust system has a reduced impact on the separation distance between the workpiece and adjacent components (e.g., exhaust system extraction nozzle(s), laser focusing optics, lasers focused on the workpiece, etc.), and in fact can help control these separation distances through pressure control. The temperature of the supply air can be controlled so as to increase the stability of the temperature of the active area (e.g., the temperature inside an exhaust system extraction nozzle and/or close fitting hood positioned adjacent to the active area). This increased stability of temperature may help to stabilize the laser-scribing process due to sensitivity of laser scanners to temperature. Further, operation of an exhaust system with such a reduced exhaust load and air conditioning requirement may reduce facility costs.

In many embodiments, the flow of exhaust air and debris can be filtered to remove the debris. The filtering can be accomplished using known filters (e.g., particle filters, chemical filters, etc.). Some or all of the filtered exhaust air can be re-circulated into the flow of supply air. Re-circulation of filtered exhaust air may help to stabilize the temperature of the flow of supply air, thereby helping to stabilize the temperature in the active area, which may help to stabilize the laser-scribing process as discussed above. Re-circulation of filtered exhaust air may also reduce the amount of heat that must be added or subtracted from the flow of supply air to achieve a desired temperature for the flow of supply air, which may help to reduce air conditioning and/or heating costs as the case may be depending upon the surrounding ambient temperature.

A laser-scribing system may have more than one laser scribing the workpiece simultaneously to increase throughput. This results in a plurality of laser-scribing areas, which correspond to the scan fields of the laser scanners. (Note: The scan field corresponds to the area that can be scribed by the laser.) In many embodiments, instead of having a single large close fitting hood cover over all the individual laser-scribing areas, a plurality of separate extraction nozzles can be used to cover over each laser-scribing area. This results in much more efficient debris extraction by limiting exhaust airflow only to areas where there is debris to be extracted. This in turn also helps to reduce the lifting force imparted on the workpiece, as well as the load on the exhaust blower. The operation of an exhaust system with a reduced exhaust blower load can be done with a smaller blower that uses less power, thereby further reducing costs.

The multiple scribing lasers described previously can be mounted on a support that is able to translate on a lateral rail as driven by a controller and servo motor. Accordingly, the laser-scribing areas described previously would be able to move laterally as the scribing lasers themselves and their support are also moved laterally on the rail. In many embodiments, the plurality of separate extraction nozzles described earlier can be moved in coordination with the motion of the laser(s) below the glass substrate. This allows separate extraction nozzles to cover individual laser-scribing areas, which creates a more efficient debris extraction by limiting exhaust airflow only to areas where there is debris to be extracted. This in turn also helps to reduce the lifting force imparted on the workpiece, as well as the load on the exhaust blower.

In many embodiments, an exhaust system can be configured so as to produce sufficient airflow velocities adjacent the active area to extract substantially all particles (of the debris) from the active area and also prevent low velocity areas where particles (of the debris) can fall out of the airflow. For example, flow rates, cross-sectional areas, and internal contours can be selected and the resulting airflows can be predicted using known analytical methods and/or can be measured. A system can be configured such that the resulting airflows are sufficient to capture and convey particles (of the debris) in vertical and horizontal runs. A system can be configured such that low velocity areas are not formed where particles (of the debris) can fall out of the airflow and onto the workpiece, hood, or ducting. A system can be configured such that vortices are also not formed that will trap particles (of the debris) and prevent them from being conveyed to the filtration units.

An extraction nozzle in embodiments can be easily adjusted to optimum working height over the workpiece. In some embodiments, this can be accomplished through a combination of mechanical position control and pressure control of the flow of supply air and/or of the flow of exhaust air and debris. An extraction nozzle can be configured with removable/replaceable parts, which can provide for potential future geometric changes to improve exhaust airflow characteristics, as well as for easy maintenance and cleaning. An exhaust system can be grounded to prevent static build-up and for safety.

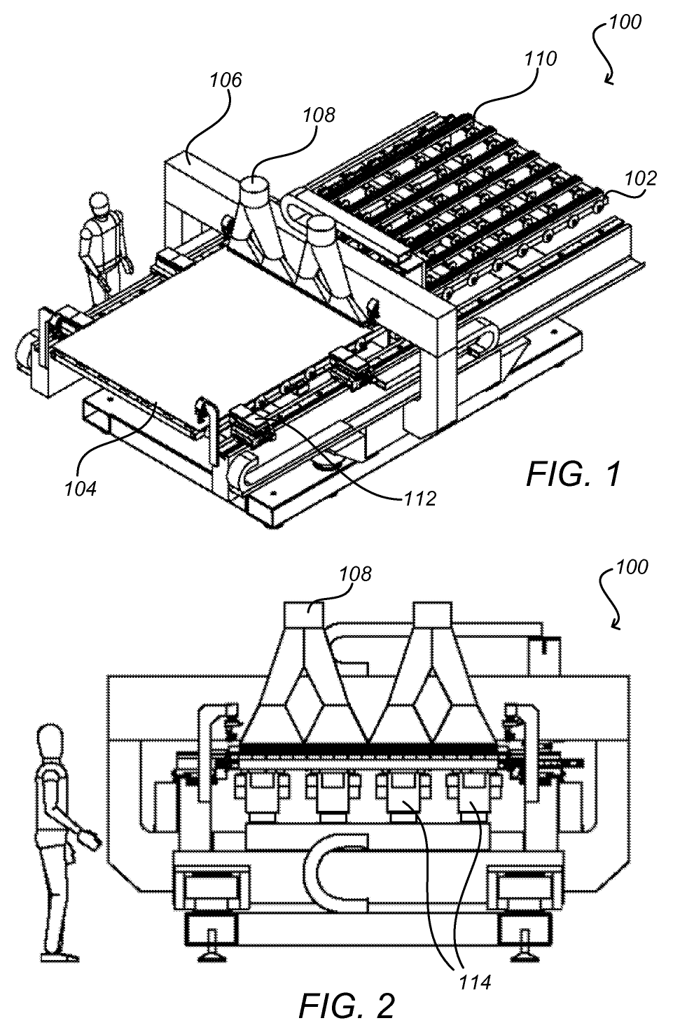

FIG. 1 illustrates an example of a laser-scribing device 100 that can be used in accordance with embodiments. The device includes a substantially planar bed or stage 102, which will typically be level, for receiving and maneuvering a workpiece 104, such as a substrate having at least one layer deposited thereon. In an example, a workpiece is able to move along a single directional vector (i.e., for a Y-stage) at a various rates (e.g., 0 m/s to 2 m/s or faster). Typically, the workpiece will be aligned to a fixed orientation with the long axis of the workpiece substantially parallel to the motion of the workpiece in the device. The alignment can be aided by the use of cameras or imaging devices that acquire marks on the workpiece. In this example, the lasers (shown in subsequent figures) are positioned beneath the workpiece and opposite a bridge 106 holding part of an exhaust mechanism 108 for extracting material ablated or otherwise removed from the substrate during the scribing process. The workpiece 104 typically is loaded onto a first end of the stage 102 with the substrate side down (towards the lasers) and the layered side up (towards the exhaust). The workpiece is received onto an array of rollers 110, although other bearing- or translation-type objects can be used to receive and translate the workpiece as known in the art. In this example, the array of rollers all point in a single direction, along the direction of propagation of the substrate, such that the workpiece 104 can be moved back and forth in a longitudinal direction relative to the laser assembly. The device can include at least one controllable drive mechanism 112 for controlling a direction and translation velocity of the workpiece 104 on the stage 102. Further description about such a system and its use is provided in co-pending U.S. Provisional Application No. 61/044,021, which is hereby incorporated herein by reference.

FIG. 2 illustrates an end view of the example laser-scribing device 100, illustrating a series of laser assemblies 114 used to scribe the layers of the workpiece. In this example, there are four laser assemblies 114, each including a laser device and elements, such as lenses and other optical elements, needed to focus or otherwise adjust aspects of the laser. The laser device can be any appropriate laser device operable to ablate or otherwise scribe at least one layer of the workpiece, such as a pulsed solid-state laser. As can be seen, a portion of the exhaust 108 is positioned opposite each laser assembly relative to the workpiece, in order to effectively exhaust material that is ablated or otherwise removed from the workpiece via the respective laser device. Each laser device actually produces two effective beams useful for scribing the workpiece. In order to provide the pair of beams, each laser assembly includes at least one beam splitting device. Although four laser devices are shown, other numbers of laser devices can be used. Although each laser device is used to produce two effective beams, each laser device can be used to produce different numbers of effective beams.

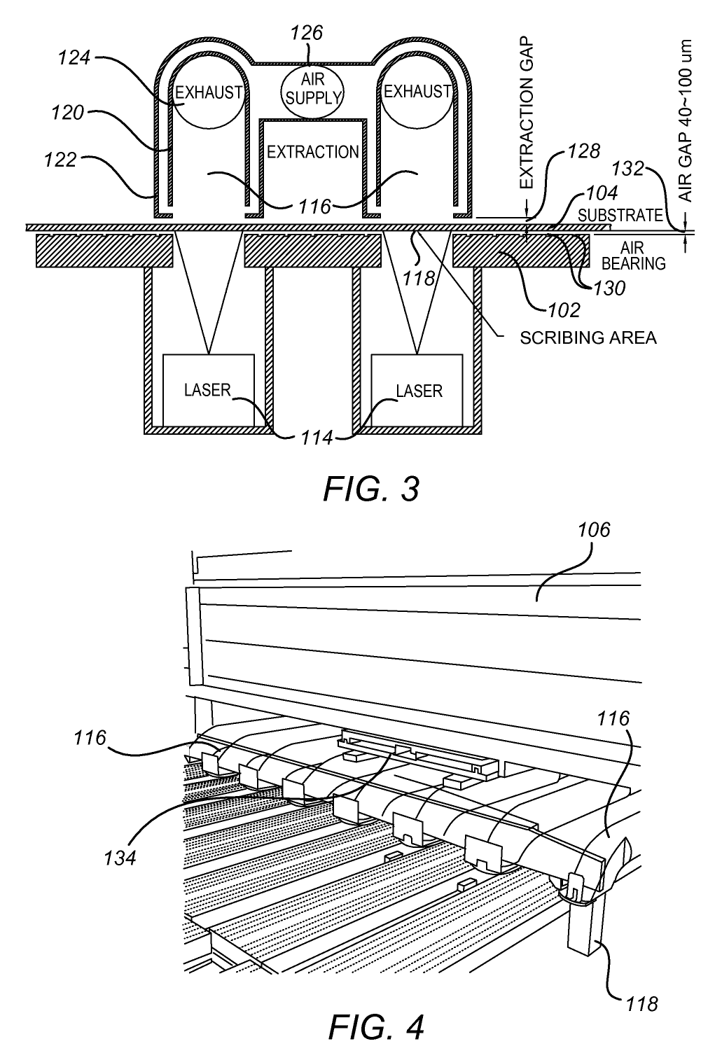

FIG. 3 illustrates components of an exhaust system that can be used in accordance with embodiments. FIG. 3 illustrates two laser assemblies 114 used to scribe the layers of the workpiece 104 and two extraction nozzles 116 used to extract the debris that result from this laser scribing. As can be seen, each extraction nozzle 116 is positioned opposite to a laser assembly 114 relative to the workpiece, in order to effectively exhaust material that is ablated or otherwise removed from the workpiece via the respective laser device. Through the use of a laser scanner, each laser device is able to effectively scribe over a laser-scribing area 118. The debris-extraction orifice illustrated is made to be large enough to completely cover over a single laser-scribing area 118, which is equal to the scan field of a laser scanner.

The extraction nozzle 116 comprises of two separate ducts: an inner duct 120 that removes a flow of exhaust air and debris from the workpiece 104 and an outer duct 122 that discharges a flow of supply air to the workpiece 104. The outer duct 122 can at least partially surround the inner duct 120, such as by a uniform spacing. Exhaust 124 removes the “exhaust air” from the inner “exhaust air” duct 120, while air supply 126 supplies the “supply air” into the outer “supply air” duct 122.

The extraction nozzle 116 is separated from the workpiece 104 by an extraction gap 128 (which, as an example, may be equal to 3 mm). Air bearings 130 forming, as an example, a 40˜100 μm air gap 132 can be used to support the workpiece 104 over the stage 102, although rollers or other bearing- or translation-type objects can also be used to receive and translate the workpiece 104 as known in the art.

The example exhaust system of FIG. 3 realizes efficient and effective debris extraction by utilizing a supply air feature. A flow of supply air is provided via an air supply 126. The flow of supply air is discharged at the periphery of the end of each nozzle (via the flow channel formed by the outer duct 122 and inner duct 120), such that the flow of exhaust air and debris pulled back into the exhaust 124 includes the flow of supply air discharged at the periphery. The flow of supply air provides at least two advantages. First, the flow of supply air reduces the amount of air drawn through the peripheral gap between the extraction nozzle and the workpiece thereby reducing the pressure drop between the exterior of the nozzle and the active area of the workpiece. The reduced pressure drop serves to reduce the lifting force imparted on the workpiece 104, allowing for improved control over the workpiece separation distances. Second, because less air is being pulled through the peripheral gap, less exterior debris is pulled through the peripheral gap and the amount of turbulence created by air pulled through the peripheral gap is reduced.

Further, the flow of exhaust air and debris that is pulled back into the exhaust system can be cleaned and at least partially directed back toward the workpiece by re-circulation into the flow of supply air. This return air feature may provide for increased stability in temperature of the active area of the workpiece 104, as pulling in air from the exterior through the peripheral gap may impact the temperature of the active area depending upon the temperature of the external air. The return air feature may stabilize the laser-scribing process due to sensitivity of the laser scanners to temperature. Without such a return air feature, it may be necessary to adjust the temperature of the external air using air conditioning or heating depending upon the temperature of the external air. Accordingly, the operation of an exhaust system with reduced air conditioning and/or heating requirements may help to decrease costs. The exhaust air can be re-circulated back to the supply air input after substantially removing the debris (e.g., by filtering through a particle filter, by filtering through a chemical filter, or by using know debris removal processes). Note that FIG. 3 does not explicitly show that the exhaust air removed by exhaust 124 is re-circulated back to become the supply air coming out of air supply 126 after debris removal. Therefore, in certain embodiments, the supply air could come from a source other than the exhaust air (e.g., air from the outside). However, in at least some applications, re-circulation of the flow of exhaust air into the flow of supply air may be the most efficient and effective way to implement the supply air feature.

As discussed, a laser-scribing system can have more than one laser scribing the workpiece simultaneously to increase throughput. This results in a plurality of laser-scribing areas, which correspond to the scan fields of the laser scanners. Each scan field can correspond to an area or region that is capable of being scribed by output from a respective laser. Therefore, instead of having a single large close fitting hood cover over all the individual laser-scribing areas, a plurality of separate extraction nozzles can be used to cover over each laser-scribing area. This may result in much more efficient debris extraction by limiting exhaust airflow to areas where there is debris to be extracted. This in turn may help to reduce the lifting force imparted on the workpiece, as well as the load on the exhaust blower. As an example, FIG. 3 displays a laser-scribing system with two laser assemblies 114, two laser-scribing areas 118, and two separate extraction nozzles 116 covering over each laser-scribing area 118.

FIG. 4 illustrates a perspective view of eight extraction nozzles 116 belonging to an exhaust system that can be used in accordance with an embodiment. As an example, FIG. 4 displays a laser-scribing system with eight laser-scribing areas 118, with each of the eight separate extraction nozzles 116 covering over an associated laser-scribing area 118. The extraction nozzles 116 can be mounted to the bridge 106 via a mount 134. The mount 134 can include an X-direction movement stage for synchronizing the lateral movement (parallel to bridge 106 in the plane of the workpiece) of the extraction nozzles 116 with the lateral movement of the laser-scribing areas. The mount 134 can also include a Y-direction movement stage for moving the extraction nozzles 116 longitudinally (perpendicular to bridge 106 in the plane of the workpiece). Such longitudinal movement can be used to uncover the laser-scribing areas 118 so that the laser-scribing areas and/or laser pulses can be observed from the top side of the workpiece (e.g., with a microscope, with an imaging device, with a beam profiler, etc.).

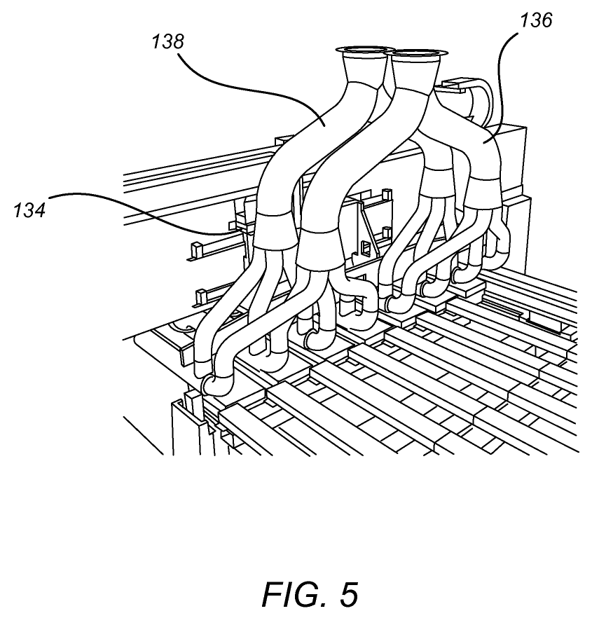

FIG. 5 illustrates a perspective view of connecting ductwork for the eight extraction nozzles (such as is shown in FIG. 4) belonging to an exhaust system that can be used in accordance with embodiments. In FIG. 5, ductworks for both the exhaust air output and the supply air input are shown. Exhaust duct assembly 136 removes the flows of exhaust air from the inner “exhaust air” ducts, while supply duct assembly 138 provides the flows of supply air to the outer “supply air” ducts. As described above, the duct assemblies can be mounted to the bridge 106 via the mount 134 and the mount 134 can include the above describe X-direction and Y-direction movement stages.

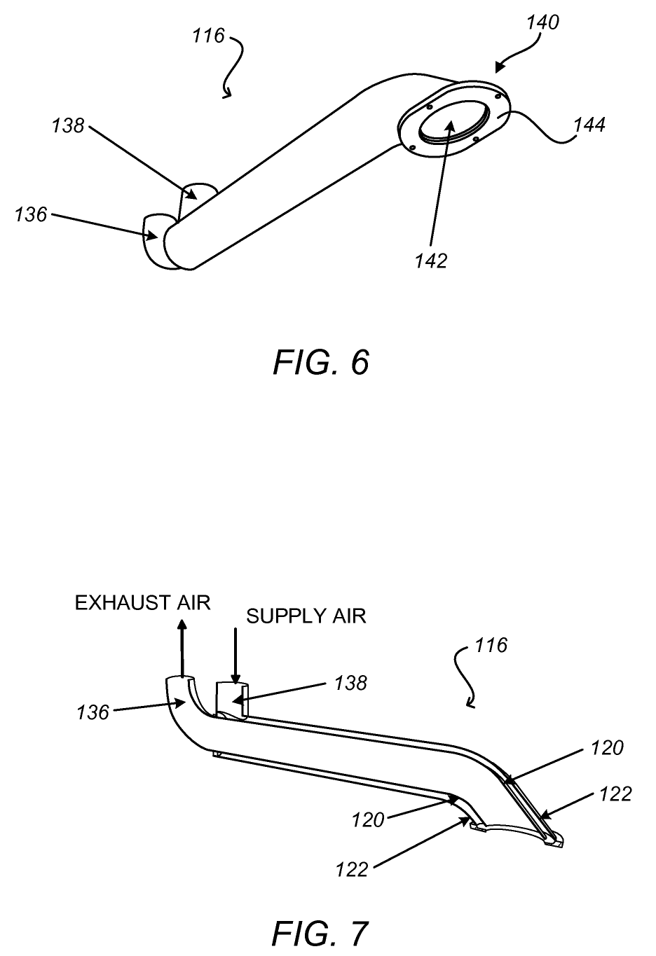

FIG. 6 illustrates an external view of an extraction nozzle 116 that can be used in accordance with embodiments. A flow of supply air is provided to the extraction nozzle 116 by way of its connection with the supply duct assembly 138 (such as shown in FIG. 5). A flow of exhaust air and debris exits from the extraction nozzle 116 by way of its connection with the exhaust duct assembly 136 (such as also shown in FIG. 5). The extraction nozzle 116 can include an end piece 140 that can be configured to be removable for maintenance and/or cleaning. The end piece 140 can also be modified or replaced so as to geometrically alter the extraction nozzle. Such geometric modification can be used to alter the flow characteristics of the extraction nozzle. The end piece 140 can define an debris-extraction orifice 142, which can be placed adjacent a workpiece for extracting debris from the workpiece, such as from an active area of the workpiece (e.g., a laser-scribing area). The end piece 140 can include a skid plate 144, which may help prevent the extraction nozzle 116 from damaging a workpiece. The skid plate 144 can be made from a material such as Teflon®, available from Dupont of Wilmington, Del., or another resin or similar material, able to reduce friction, as well as to provide resistance to high temperatures, chemical reaction, corrosion, and stress-cracking.

FIG. 7 illustrates a cross-sectional view of an extraction nozzle 116 (shown in FIG. 6) that can be used in accordance with embodiments. The extraction nozzle 116 can include two separate ducts: an inner duct 120 for removing a flow of exhaust air and debris from the workpiece and an outer duct 122 that provides a flow of supply air to the workpiece. Although not required, the outer duct 122 can at least partially surrounds the inner duct 120, and can do so in a variety of ways. For example, the outer duct 122 and the inner duct 120 can be concentrically located. The outer duct 122 and the inner duct 120 can have various shapes and be separated by a variety of dimensions. For example, the outer duct 122 can surround the inner duct by a uniform spacing over at least a portion of the inner duct 120. FIG. 7 shows these two ducts, as well their connections with the exhaust duct assembly 136 and the supply air duct assembly 138.

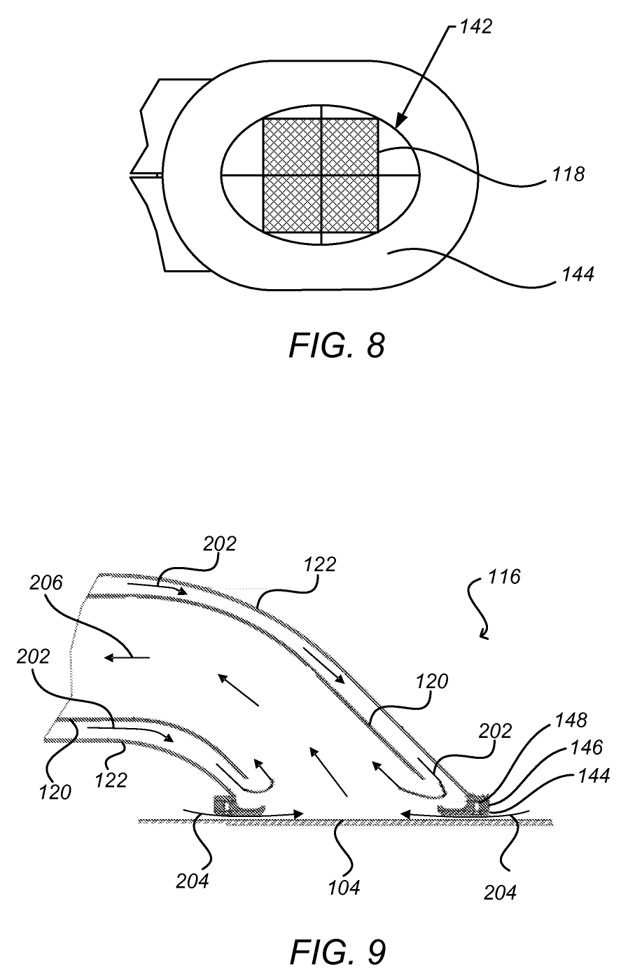

FIG. 8 illustrates a debris-extraction orifice 142 that can be used in accordance with embodiments. A laser scan field area 118 is shown relative to the debris-extraction orifice 142 to illustrate that the debris-extraction orifice 142 can be configured to completely cover over a single laser-scribing area, which is equal to the scan field of a laser scanner. A laser scan field area 118 can come in a variety of shapes and sizes, such as the 60 mm×60 mm area shown. An end piece can be used to define the debris-extraction orifice 142 and can be configured to be removable. As described above, the extraction nozzle can include a skid plate 144. The skid plate 144 can be used to cover the periphery of the extraction nozzle that extends beyond the extraction nozzle opening.

FIG. 9 illustrates the flow of “supply air” (denoted by supply air arrows 202), the flow of “gap air” (denoted by gap air arrows 204), and the flow of “exhaust air” (denoted by exhaust air arrows 206) near the opening of an extraction nozzle 116 that can be used in accordance with embodiments. The airflows can be configured so as to extract substantially all debris from the scan field of the laser on a workpiece 104. The amount of gap air 204 drawn through the perimeter gap between the extraction nozzle 116 and the workpiece 104 can be adjusted by adjusting the gap between the extraction nozzle 116 and the workpiece 104 and/or by adjusting the rate of flow of the supply air 202 relative to the rate of flow of the exhaust air flow 206. The pressure differential between the inside of the extraction nozzle and the outside of the extraction nozzle can likewise be adjusted by adjusting the gap and/or by adjusting the relative flow rates between the flow of supply air 202 and the flow of exhaust air 206. For example, decreasing the perimeter gap and/or increasing the rate of flow of the exhaust air 206 relative to the rate of flow of the supply air 202 will cause an increase in the pressure drop from the outside of the extraction nozzle 116 to the inside of the extraction nozzle (i.e., adjacent the active area of the workpiece 104). Conversely, increasing the perimeter gap and/or increasing the rate of flow of the supply air relative to the rate of flow of the exhaust air will decrease the pressure drop from the outside of the extraction nozzle to the inside of the extraction nozzle.

The extraction nozzle 116 illustrated in FIG. 9 includes two separate ducts: an outer duct 122 providing a flow of supply air 202 to a workpiece 104 and an inner duct 120 removing a flow of exhaust air 206 and debris from the workpiece 104. As described above, the outer duct 122 can be configured to at least partially surround the inner duct 120, such as by a uniform spacing. The extraction nozzle 116 can be positioned above the workpiece 104 by some distance (for example 3 mm in an embodiment). In the event the extraction nozzle 116 comes in contact with the workpiece 104, the skid plate 144 may help to prevent the extraction nozzle 116 from damaging the workpiece 104. A removable component 146 is an example of extraction nozzle components that can be removed and replaced for potential future geometric changes to improve exhaust airflow characteristics, as well as for easy maintenance and cleaning. In this embodiment, the removable component 146 can be coupled with the outer duct 122. The removable component 146 and the skid plate 144 can be coupled with the extraction nozzle 116 in a variety of ways, such as being fastened to the outer duct 122 via screw 148.

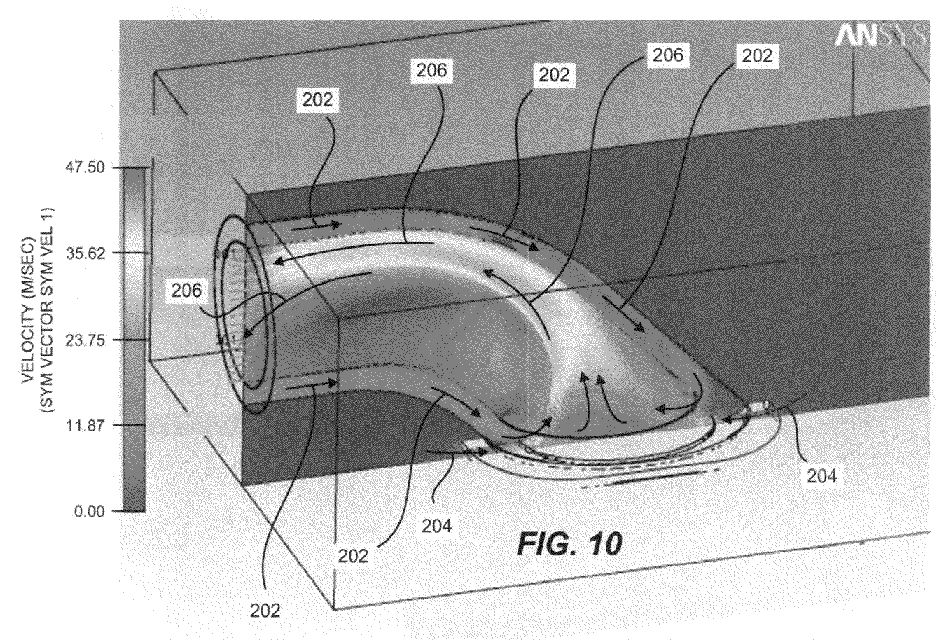

FIG. 10 illustrates computer simulation results for air flow velocities along the centerline plane of an extraction nozzle that can be used in accordance with embodiments. The simulation results depict the magnitude of airflow velocities using a shaded-contour plot. Such computer simulation results can be used to configure the exhaust system flow rates, the extraction nozzle geometry, and the perimeter gap between the extraction nozzle and the workpiece. The simulation results can be used to predict a pressure differential caused by the operation of a nozzle, and thereby be used to predict the level of lifting force imposed upon the workpiece.

Such computer simulations can be used to configure the exhaust system and extraction nozzle to produce sufficient airflow velocities to extract substantially all particles (of the debris) from an active area of a workpiece and also prevent low velocity areas where particles (of the debris) can fall out of the airflow. Airflow velocities of sufficient magnitude can be produced to capture and convey particles (of the debris) in vertical and horizontal runs. Low velocity areas can be avoided where particles (of the debris) may fall out of the airflow and onto the workpiece, hood, or ducting. Vortices can be avoided that may trap particles (of the debris) and prevent them from being conveyed to the filtration units.

The computer simulation further illustrates the operation of an extraction nozzle in accordance with embodiments. The flow of supply air 202 travels down an outer duct where it is discharged to the active area of the workpiece at the perimeter of the debris-extraction orifice. A flow of gap air 204 is drawn through the perimeter gap. The flow of supply air 202 and the flow of gap air 204 combine in the region of the debris-extraction orifice of the extraction nozzle, thereby supplying the flow of air that becomes the flow of exhaust air 206. The combined action of the air flows serves to remove debris from the active area of the workpiece.

The specification and drawings are, accordingly, to be regarded in an illustrative rather than a restrictive sense. It will, however, be evident that various modifications and changes may be made thereunto without departing from the broader spirit and scope of the invention as set forth in the claims. Further, embodiments may be implemented individually or in any combination as needed to realize benefits of the present invention.

What is claimed is:

1. A debris-extracting exhaust system, the system comprising:
an extraction nozzle that includes at least one debris-extraction orifice, each debris-extraction orifice being configured for placement adjacent to an active area of a workpiece; and
a source of exhaust operable to extract a flow of exhaust and debris from the active area through each debris-extraction orifice,
wherein the extraction nozzle includes, for each debris-extraction orifice, a first duct coupled with the debris-extraction orifice and a second duct coupled with the debris-extraction orifice, the second duct being configured to deliver a flow of supply air towards the active area and the first duct being configured to remove a flow of exhaust air and debris from the active area.

2. A system according to claim 1, wherein the second duct encloses at least a portion of the first duct.

3. A system according to claim 2, wherein the second discharges the supply air at the perimeter of the debris-extraction orifice.

4. A system according to claim 1, further comprising a filtering device for removing the debris from the flow of exhaust air, whereby the filtered exhaust air is able to be re-circulated into the flow of supply air.

5. A system according to claim 4, wherein the filtering device includes a particle filter or a chemical filter.

6. A system according to claim 1, wherein each debris-extraction orifice is configured to extract debris from a single laser-scribing area, and wherein the laser-scribing area is an area on the workpiece that can be processed by a laser scanner.

7. A system according to claim 1, further comprising a translation mechanism for moving the extraction nozzle so that each debris-extraction orifice is moved in coordination with movement of the active area.

8. A system according to claim 1, wherein the system is configured to ensure:
that airflow velocities within the first duct are sufficiently high to capture and convey substantially all debris from the workpiece; and
that no vortex is formed within the first duct that will trap the debris and prevent the debris from being conveyed along the first duct.

9. A system according to claim 1, wherein a separation distance between the debris-extraction orifice and the workpiece is adjustable.

10. A system according to claim 1, wherein the extraction nozzle includes at least one end piece that can be removed for maintenance, cleaning, or geometric modification, and wherein each end piece defines the debris-extraction orifice.

11. A system according to claim 1, wherein a pressure differential between opposing sides of the active area is less than 1.0 psi.

12. A method of using airflow to remove debris from a workpiece, the method comprising:
providing a flow of supply air;
discharging the flow of supply air toward an active area of a workpiece; and
extracting a flow of exhaust air and debris from the active area through a debris-extraction orifice.

13. A method according to claim 12, wherein the direction and rate of flow of the supply air is sufficient to maintain a minimum separation between the workpiece and the debris-extraction orifice.

14. A method according to claim 12, further comprising:
filtering the flow of exhaust air to substantially remove the debris; and
re-circulating air from the filtered flow of exhaust air into the flow of supply air.

15. A method according to claim 14, wherein filtering the flow of exhaust air includes processing through a particle filter or a chemical filter.

16. A method according to claim 12, wherein the discharge of supply air and the extraction of exhaust air and debris are substantially limited to one or more areas of the workpiece that are being laser scribed.

17. A method according to claim 12, wherein the flow of supply air is provided through a first duct to deliver the flow of supply air along an extraction nozzle toward the active area, and wherein the flow of exhaust air is extracted through a second duct to deliver the exhaust air and debris along the extraction nozzle away from the active area.

18. A debris-extracting exhaust system, the system comprising:
a plurality of extraction nozzles, each extraction nozzle including a debris-extraction orifice configured for placement adjacent to an associated active area of a workpiece,
a source of supply air operable to direct a flow of supply air through a first duct of each extraction nozzle toward the associated active area; and
a source of exhaust operable to extract a flow of exhaust air and debris from the associated active area through each second duct.

19. A system according to claim 18, wherein the direction and rate of flow of the supply air is sufficient to maintain a minimum separation between the workpiece and each extraction nozzle.

20. A system according to claim 18, wherein a pressure differential between opposing sides of each active area is less than 1.0 psi.

21. A system according to claim 18, further comprising a filtering device for removing debris from the flows of exhaust air, whereby the filtered exhaust air is able to be re-circulated into the flows of supply air.

22. A system according to claim 18, further comprising a translation mechanism for moving the extraction nozzles so that each debris-extraction orifice is moved in coordination with movement of its associated active area.
